(19) United States
(12) Patent Application Publication
(10) Pub. No.: US 2013/0098558 A1
(43) Pub. Date: Apr. 25, 2013

(54) LAMINATING SYSTEM, LAMINATING POUCH, AND METHOD OF MANUFACTURE

(71) Applicant: ACCO BRANDS CORPORATION, Lincolnshire, IL (US)

(72) Inventors: Rong Liu, Vernon Hills, IL (US); Jesse Fisher, Crystal Lake, IL (US); Moudong Liu, Shenzhen (CN); Dhimat Desai, South Barrington, IL (US); Ming Lui, Hong Kong (CN); Bob Xu, Guangzhou (CN)

(73) Assignee: ACCO BRANDS CORPORATION, Lincolnshire, IL (US)

(21) Appl. No.: 13/657,562

(22) Filed: Oct. 22, 2012

Related U.S. Application Data
(60) Provisional application No. 61/550,021, filed on Oct. 21, 2011.

(51) Int. Cl. B32B 37/14; B32B 37/30

(52) U.S. Cl. 156/378; 156/264; 156/381

(57) ABSTRACT

In one aspect, the invention provides a laminating pouch. The laminating pouch includes first and second plies bonded by a pre-sealed edge. The laminating pouch also includes indicia in the pre-sealed edge that correspond to a property of the laminating pouch. The laminating pouch is configured to receive an article between the first and second plies and laminate the article when processed in a laminator.

### CROSS-REFERENCE TO RELATED APPLICATIONS

This application claims priority to co-pending U.S. Provisional Patent Application No. 61/550,021 filed on Oct. 21, 2011, the entire content of which is incorporated herein by reference.

### BACKGROUND OF THE INVENTION

The present invention relates to laminating sheets, for example translucent sheets or two-ply jackets with heat-activated adhesive for adhering to sheet-type objects, such as paper, photos, etc. A conventional two-ply laminating jacket has heat-activated adhesive on the interior side of each ply. Before being inserted into a laminating machine to laminate a sheet-type object, the adhesive gives each ply of the laminating jacket a slightly cloudy, partially opaque appearance although the base substrate is a substantially transparent or translucent sheet material. When heated in the laminating machine, the adhesive cures to a substantially transparent appearance so that the sheet-type object is clearly visible while being securely laminated between the two plies of the jacket.

Laminating material is produced in a variety of configurations having different sizes, shapes, thicknesses, types of adhesive, etc. The specifications of the laminating material, including all of the relevant information that a user may need to select the desired laminating material and/or configure a laminating machine for proper operation with a particular laminating material, are generally located with or on the packaging in which the manufacturer supplies the laminating material. This may complicate the laminating task for a user if the laminating material becomes separated from the original packaging.

Selecting the thickness of the laminating foil or sheet can provide a desired flexibility or stiffness to the laminated sheet material. It is implied that more thermal energy has to be provided for hot sealing thick laminating foils, than has to be provided for hot sealing thin laminating foils made of the same materials. Laminating units, which are configured for processing laminating foils with different thickness therefore have to be adaptable to the thickness of the respective thickness of the laminating foil to be processed, so that on the one hand sufficient thermal energy is provided for welding the sheet material, and on the other hand the laminating foil does not overheat so that it is damaged. Therefore such laminating units comprise adjustment apparatuses through which the temperature of the laminating apparatus and/or the pass through velocity can be adapted to the respective thickness of the laminating foil by hand.

However, in practical applications it has become apparent that there are frequently operator errors, in particular when, as in large offices, numerous individuals have access to a laminating unit. An operator error has the consequence that the lamination is insufficient for a heat impact which is too small, thus the laminated sheet material is not protected sufficiently, or that the laminating foil overheats for excessive heat impact and thus sticks to the laminating rollers which causes severe damages to the laminating unit. Furthermore, the laminated sheet material is damaged, so it is unreadable. The latter condition is mostly non repairable and in the worst case causes the destruction of the document.

In addition, misaligned feeding, angled feeding or off-center feeding of the pouch can cause the pouch to jam at the edge of the roller set within the laminating unit.

### SUMMARY

In one aspect, the invention provides a laminating pouch. The laminating pouch includes first and second plies bonded by a pre-sealed edge. The laminating pouch also includes indicia in the pre-sealed edge that correspond to a property of the laminating pouch. The laminating pouch is configured to receive an article between the first and second plies and laminate the article when processed in a laminator.

In another aspect, the invention provides a method of forming a laminating pouch. A web of laminating film is provided. The web is divided lengthwise into at least three ribbons, including a first outer ribbon, a second outer ribbon, and a center ribbon. A first laminating pouch is formed by joining a portion of laminating film from the first outer ribbon and a portion of laminating film from the second outer ribbon. A second laminating pouch is formed by joining two portions of laminating film from the center ribbon.

In another aspect, the invention provides a laminating system including a laminating pouch and a laminator configured to laminate an article within the laminating pouch. The laminator includes an inlet configured to receive the laminating pouch and a detector. The laminating pouch includes a pre-sealed leading edge configured to be inserted into the inlet of the laminator. The pre-sealed leading edge contains indicia. The detector is configured to read the indicia and to detect a property of the laminating pouch from the indicia.

In another aspect, the invention provides a laminating system including a laminating pouch, a laminator configured to receive the laminating pouch and to laminate an article within the laminating pouch, and a jam detection system. The laminator includes a set of rollers disposed in a processing section of the laminator. The jam detection system includes a first temperature sensor operable to detect a temperature within the processing section. The jam detection system further includes a second temperature sensor spaced downstream of the set of rollers. The jam detection system further includes a controller operable to detect a jam by monitoring a signal of the second temperature sensor after the first temperature sensor indicates that the laminating pouch has been inserted into the laminator.

In another aspect, the invention provides a laminating system including a laminating pouch, and a laminator. The laminator includes a motor and a set of rollers disposed in a processing section of the laminator and configured to be driven by the motor. The laminator is configured to receive the laminating pouch and to laminate an article within the laminating pouch. The laminating system further includes a temperature sensor operable to detect a temperature within the processing section of the laminator. The laminating system further includes a controller. The controller is operable to receive a signal from the temperature sensor to determine a temperature change, correlate the temperature change to a predetermined operating speed of the motor, and provide an electrical signal to the motor corresponding to the predetermined operating speed of the motor.

Other aspects of the invention will become apparent by consideration of the detailed description and accompanying drawings.

### BRIEF DESCRIPTION OF THE DRAWINGS

FIG. 1 is a perspective view of a laminator and laminating pouch according to one aspect of the invention. A cover of the laminator is made transparent to illustrate the interior.

FIG. 2 is an exploded assembly view of a portion of the laminator and the laminating pouch of FIG. 1.

FIG. 3 is a perspective view of an alternate laminator and laminating pouch according to another aspect of the invention. A cover of the laminator is removed to illustrate the interior.

FIG. 4 is a flow diagram illustrating a control flow for a laminator of the present invention.

FIG. 5 is a plan view of a laminating pouch having a first thickness and a corresponding first code in the pre-sealed leading edge thereof.

FIG. 6 is a plan view of a laminating pouch having a second thickness and a corresponding second code in the pre-sealed leading edge thereof

FIG. 7 is a plan view of a laminating pouch having a third thickness and a corresponding third code in the pre-sealed leading edge thereof

FIG. 8 is a plan view of a laminating pouch having a fourth thickness and a corresponding fourth code in the pre-sealed leading edge thereof.

FIG. 9 is a plan view of an alternate laminating pouch having a feed-direction length that is greater than a transverse width. Although not illustrated, the laminating pouch may include indicia in the pre-sealed leading edge, and may be part of a set of laminating pouches of different thicknesses having different indicia in their respective pre-sealed leading edges.

FIG. 10 is a perspective view of a master roll from which sheets used to manufacture laminating pouches are cut.

FIG. 11 is a plan view of a laminating pouch illustrating the pre-sealed edge and the extrusion direction.

FIG. 12 is a cross-sectional view of a laminating unit having a jam detection system.

FIG. 13 is a first flow diagram illustrating a control flow of a first jam detection method.

FIG. 14 is a second flow diagram illustrating a control flow of a second jam detection method.

FIG. 15 is a third flow diagram illustrating a control flow of a third jam detection method.

FIG. 16 is a cross-sectional view of a laminating unit having a system for automatically controlling heat and speed without user intervention.

FIG. 17 is a flow diagram illustrating a control flow of a laminating process with automatic control.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

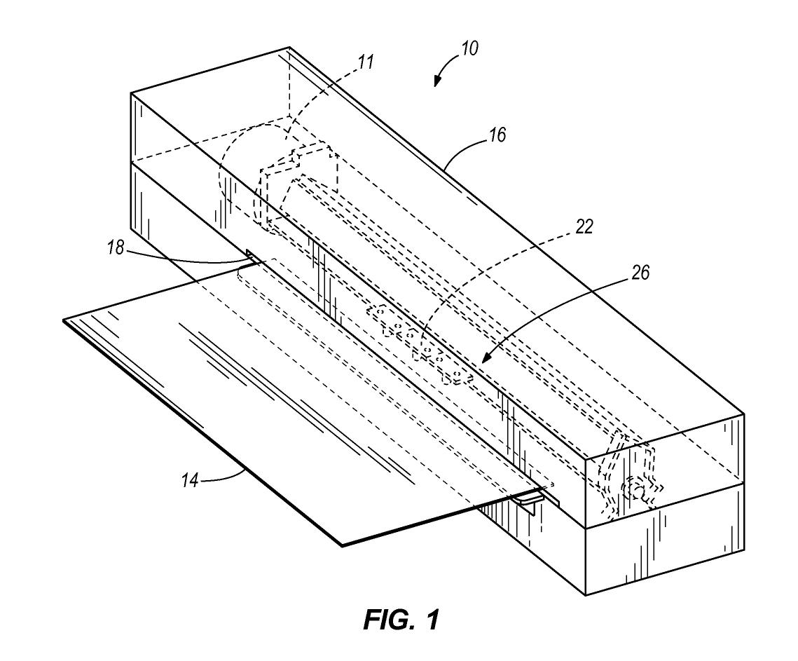

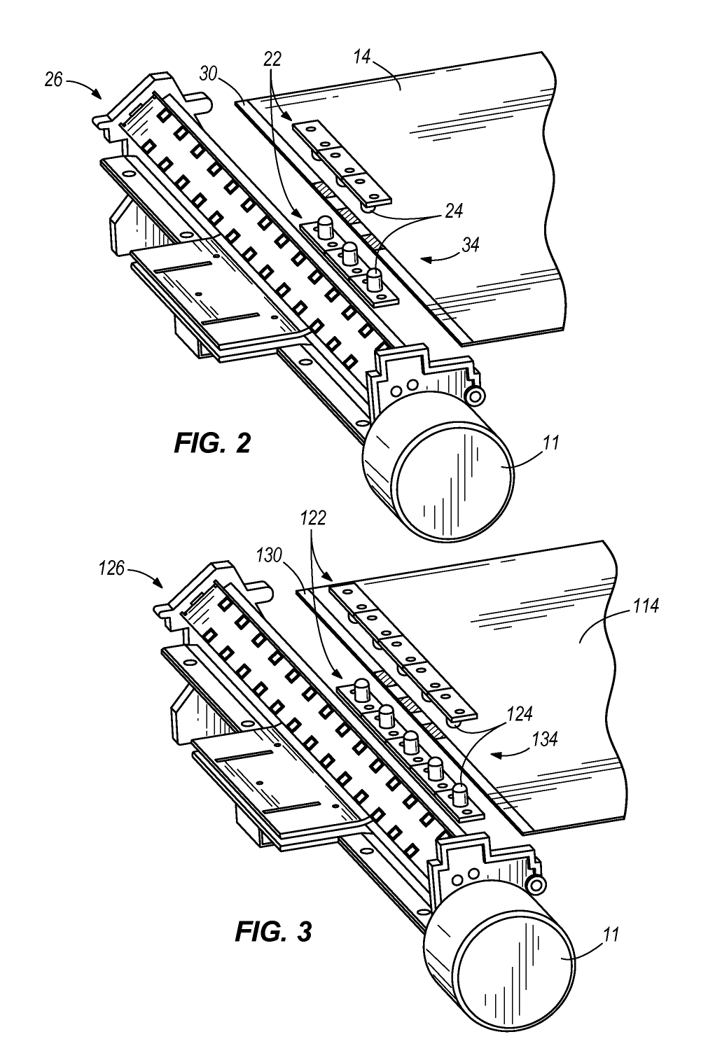

A lamination unit or machine 10 (sometimes referred to herein simply as “laminator”) is illustrated in FIGS. 1 and 2. The laminator 10 receives an article (e.g., a document; not shown) wrapped in laminating material 14 and converts the inserted article and laminating material 14 into a laminated product by curing the laminating material 14 via heat and/or pressure within a processing section 26 of the laminator 10. The heat and/or pressure activate an adhesive of the laminating material 14 and may be applied to the laminating material 14 by a set of rollers (not shown) driven by a motor 11 in a conventional manner. The article and laminating material 14 are inserted into a housing 16 of the laminator 10 via a slit-like inlet 18. Inside the housing 16, adjacent the inlet 18, is positioned a detector module 22 which is discussed in further detail below. The detector module 22 is positioned between the inlet 18 and the processing section 26 of the laminator 10, and may be centrally located along the width of the inlet 18.

In the illustrated constructions, the laminating material is in the form of a pouch 14. The lamination pouch 14 is created by bonding two laminating plies via a sealed leading edge 30 (e.g., by applying fixed temperature and pressure over a fixed period of time in a manufacturing process of the laminating pouch). Thus, the sealed leading edge 30 is a “pre-sealed” edge formed in a process separate from and before the laminating process of the document with the laminator 10. It should be understood that the pre-sealed edge 30 is an edge strip having a small but finite width along the leading edge of the pouch 14. The lamination pouch 14 includes indicia 34 or coded information readable by the detector module 22 of the laminator 10. The indicia 34 can be used to convey information about the laminating pouch 14 to the laminator 10, which information can then be used by the laminator 10 to automatically adjust settings of the laminator 10 to carry out a satisfactory lamination process with limited or no user dependency. Once processed by the laminator 10, the indicia 34 are not visible by the detector module 22 of the laminator 10 or the human eye.

In some constructions, the indicia 34 are created within the pre-sealed edge strip 30, and may be completely contained within the pre-sealed edge strip 30. The indicia 34 can be created in the pre-sealed edge strip 30 by leaving selected portion(s) of the pre-sealed edge strip 30 un-sealed to create at least one un-sealed segment or bar having a transparency and reflectivity difference with the remainder of the pre-sealed edge strip 30. Alternate means of creating the indicia 34 are possible and may include printing with dyes or inks, and the indicia 34 may or may not be confined within the pre-sealed leading edge strip 30. A conventional pouch will have a leading edge strip that is completely sealed by heat and pressure. The sealing process completely activates and cures the adhesive coating, changing it from a translucent matte finish to a substantially transparent finish. The main lamination field below the sealed leading edge strip is translucent, but not transparent, because the adhesive coating there is not yet activated. The width of a sealed leading edge strip 30 may be about 2-3 mm, and the whole leading edge strip 30 (excluding the indicia 34) is completely transparent. By locating the indicia 34 in the leading edge strip 30 of the pouch 14, the indicia 34 cannot be interfered with by the inserted article (a sheet or other document inserted between the plies of the pouch 14). Likewise, the indicia 34 will not obstruct or otherwise reduce the visibililty of the article after it is laminated (e.g., no silvering).

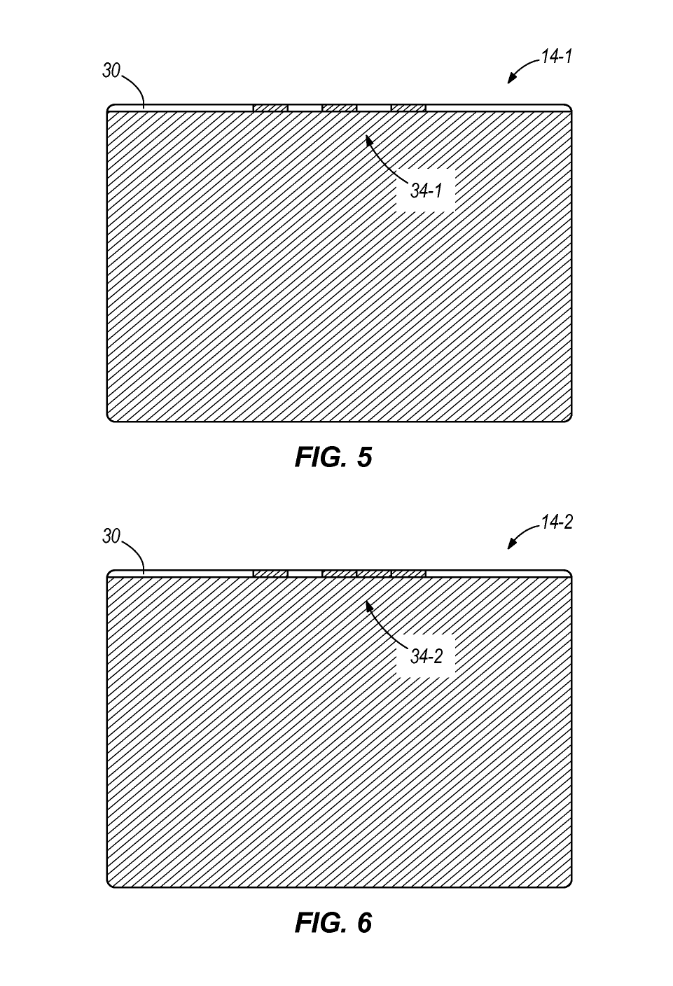

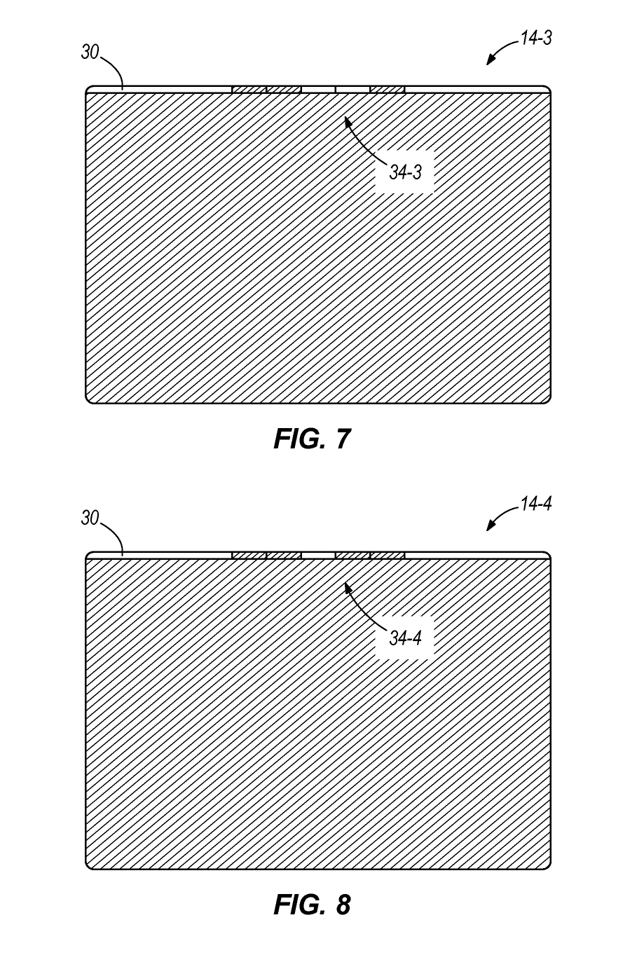

The indicia 34 can form special coding, which can indicate various information about the laminating pouch 14, including but not limited to film thickness, material construction of the film, pouch size, adhesive type, etc. Varying the specific locations and/or widths of the sealed and unsealed segments along the leading edge is used to form specific coding information for the pouch 14. The indicia 34 may include two outer bars (not shown) that can be used to ensure the pouch 14 is aligned relative to the laminator 10 for reading by the detector module 22. For example, the detector module 22 will only attempt to read the indicia 34 once the two outer bars are determined to be present. This prevents misreading of the indicia 34 if the pouch 14 is misaligned or skewed incorrectly to prevent poor lamination and jamming that might occur if the laminator 10 receives incorrect information about the inserted pouch 14. A set of pouches 14-1, 14-2, 14-3, 14-4 of different thicknesses are illustrated in FIGS. 5-8. Each pouch includes unique indicia 34-1, 34-2, 34-3, 34-4 in the pre-sealed leading edge strip 30 to be uniquely identified by the laminator 10. In some constructions, the indicia 34 are located along a central ⅓ of the length of the pre-sealed edge strip 30.

With reference to FIG. 2, the detector module 22 can include a plurality of sensor elements 24 (e.g., light sensors) spaced along the width (transverse to the feeding direction) to facilitate reading of the indicia 34. In some constructions, the sensor elements 24 are spaced along the central ⅓ of the width to correspond with the location of the indicia 34. The sensor elements 24 can be configured to send/receive electromagnetic radiation of a particular frequency or frequency range in some constructions. The detector module 22 can utilize UV radiation, infrared radiation, or LEDs for example.

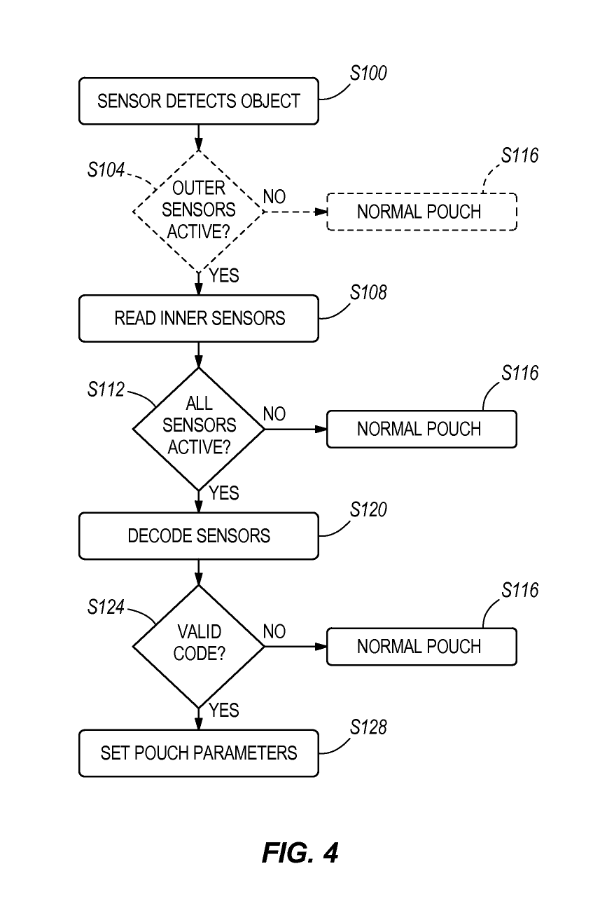

A flow diagram of one exemplary control process for a laminating method of the laminator 10 with the pouch 14 is provided in FIG. 4. To begin a lamination process, an entrance sensor of the laminator 10 detects the insertion of the laminating pouch 14 in step S100. The detector module 22 may act as the entrance sensor, or the entrance sensor may be a separate sensor (e.g., contact switch, optical sensor, etc.). Next, if the detector module 22 is configured to read outer bars (not shown) of the indicia 34 as described above, the detector module 22 first determines if the outer bars are present in step S104. If the outer bars are not present, the laminator 10 operates at a default setting corresponding to a normal or conventional laminating pouch (i.e., a pouch not including indicia) in step S116. If the detector module 22 indicates that only a portion of the outer bars is present, the pouch 14 may be misaligned, and the laminator 10 may suspend the laminating process. If the outer bars are present, (or if the detector module 22 is not configured to read the outer bars), the laminator 10 proceeds to attempt to read signals from the inner sensors (i.e., sensor elements 24) in step S108. The laminator 10 first determines if the sensor elements 24 are active in step S112. If one or more of the sensor elements 24 are not active or functioning properly, the laminator operates at the default setting S116. If all the sensor elements 24 are active and functioning properly, the laminator 10 proceeds to step S120 and decodes a code conveyed by the indicia 34. The laminator 10 determines the validity of the code in step S124. If the code conveyed is invalid, the laminator operates at the default setting S116. If the code is valid, the laminator 10 can automatically set one or more lamination parameters (lamination temperature, speed, pressure, etc.) according to the code in step S128. By this method, optimum lamination results can be achieved and user errors can be prevented.

Because the indicia 34 are located along the leading edge only (e.g., within the pre-sealed leading edge strip 30), the decoding time and distance is very short. There is also no need for feeding rollers since the indicia 34 are on the leading edge only. “Silvering” or other obscuring of the article being laminated is not an issue since the indicia 34 are not in the main lamination area.

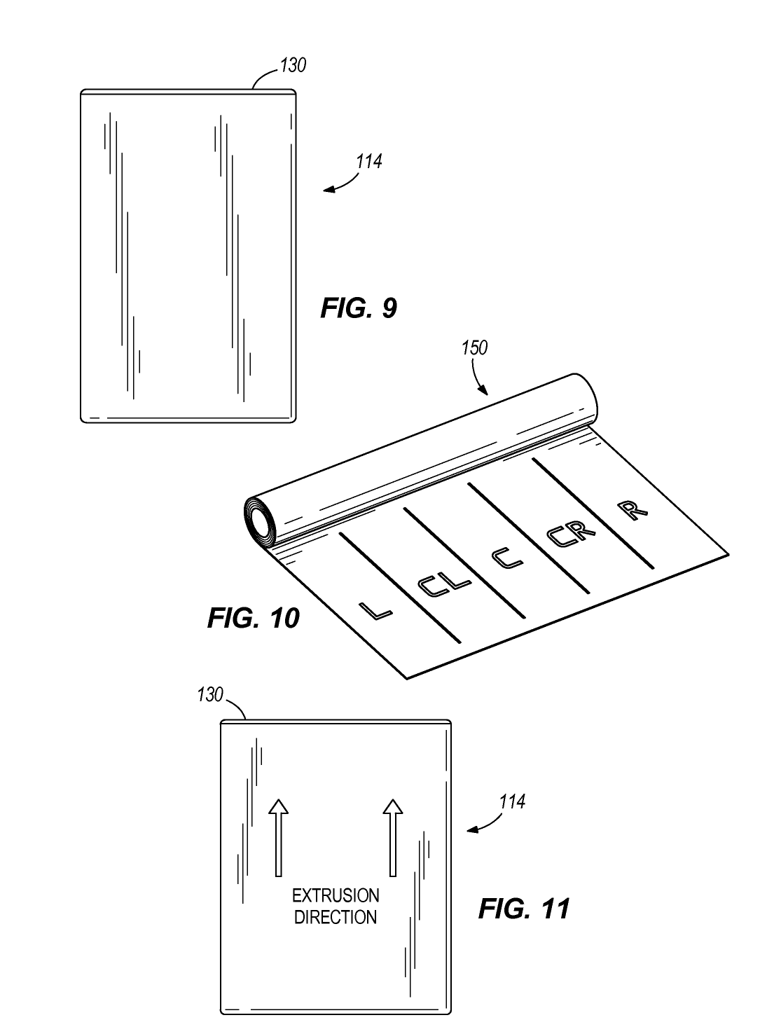

FIG. 3 illustrates a slightly modified laminating system in which a laminating pouch 114 includes indicia 134 formed in a sealed leading edge strip 130 like that of the pouch 14, but the leading edge strip 130 (i.e., the width of the pouch 114 transverse to the feeding direction) is shorter than the length of the pouch 114 in the feeding direction. The pouch 114 is also shown in plan view in FIG. 9 to illustrate one example of the size of the pre-sealed leading edge strip 130 relative to the pouch 114 (the indicia 134 are omitted for simplicity), although other pouch sizes are contemplated and in fact, may be designated by the indicia 134. The laminator 110 includes a processing section 126 configured to apply pressure and/or heat to the laminating pouch 114 to laminate an article (e.g., a document) placed therein. A detector module 122 is provided between a feeding opening (not shown) and the laminating mechanism 126. The detector module 122 is similar in structure and operation to the detector module 22 described above, but the detector module 122 of FIG. 3 includes five sensor elements 124. Although the principle of operation of the detector module 122 is similar to the detector module 22 described above, the detector module 122 having additional sensor elements 124 may increase the sensitivity or resolution capability of the module 122 to read additional information or read the same information more clearly.

FIGS. 10-11 relate to the manufacturing of pouches according to one or more aspects of the present invention. FIG. 10 illustrates a master roll 150 of laminating film used to produce 2-ply pouches (e.g., pouches 14, 114). The master roll 150 can be divided or slit into a plurality of lengthwise ribbons L, CL, C, CR, R. To maximize the lamination output, the front and back sheets or plies of a laminating pouch are cut from opposite sides of the master roll 150. In other words, the left and right sections L, R are joined to form 2-ply pouches, and the center-left and center-right sections CL, CR are joined to form 2-ply pouches. Material from the center section C is used to form additional 2-ply pouches. Additionally, as shown in FIG. 11, the sealing of the leading edge strip 130 is performed so that the strip 130 runs transverse to the direction of material (film) extrusion.

One way to form the indicia 34, 134 along the leading edge strip 30, 130 in a manufacturing process of the pouch 14, 114, is to modify a sealing tool, such as a hot press (not shown). Normally used to seal the entire leading edge strip 30, 130, the hot press may be modified to leave one or more portions recessed. Thus, during the edge sealing process, the seal press only contacts the pouch 14, 114 in select areas to form sealed portions, and the recessed portion(s) will remain spaced from the pouch to leave unsealed bars/segments as desired. As such, the forming of the indicia 34, 134, such as a bar code, can be incorporated into the already-present leading edge sealing process to minimize the cost impact on the coded pouch 14, 114.

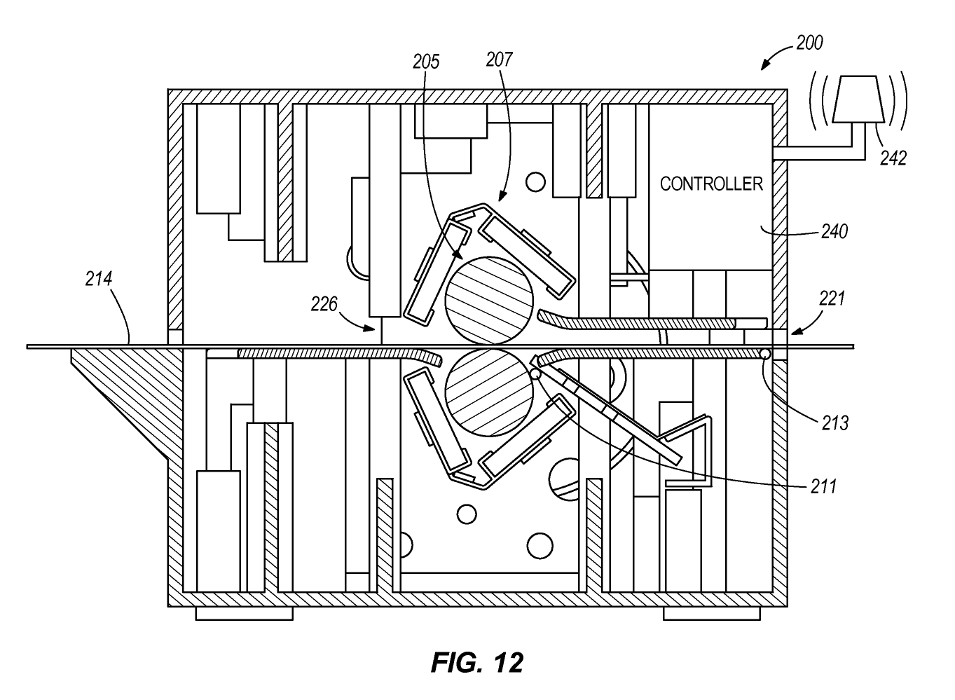

A lamination unit 200 and method are also contemplated for providing a novel jam detection method. The lamination unit 200 and jam detection process are illustrated in FIGS. 12-15. As shown in FIG. 12, the laminator 200 includes a set of rollers 205 disposed within a processing section 226 of the laminator 200. The rollers 205 are heated by corresponding heater assemblies 207 configured to activate the adhesive of a laminating pouch 214 to laminate a document or other article (not shown) therein.

The jam-detection system of the laminator 200 incorporates two sensor assemblies 211, 213. The first sensor 211 is a temperature sensor (e.g., a negative temperature coefficient or NTC thermistor) that is located against the roller surface of one of the rollers 205 and used to communicate with a controller 240 to control the heat output of the heater assemblies 207 and thus the temperature of the rollers 205. The first sensor 211 can, for example, detect the roller surface temperature directly and communicate the information to the controller in a conventional manner to adjust heating accordingly. However, this same first sensor 211 can also be used to detect lamination material inserted into the laminator 200 since it can detect a drop in surface temperature of the roller 205 when a fresh pouch, which absorbs heat from the rollers 205, has begun passing through the rollers 205. The second sensor 213 is located at or adjacent an exit 221 of the laminator 200 where the laminated product comes out of the laminator 200. The second sensor 213 can be an NTC thermistor like the first sensor 211 or another type of temperature sensor configured to detect a temperature change at the exit 221.

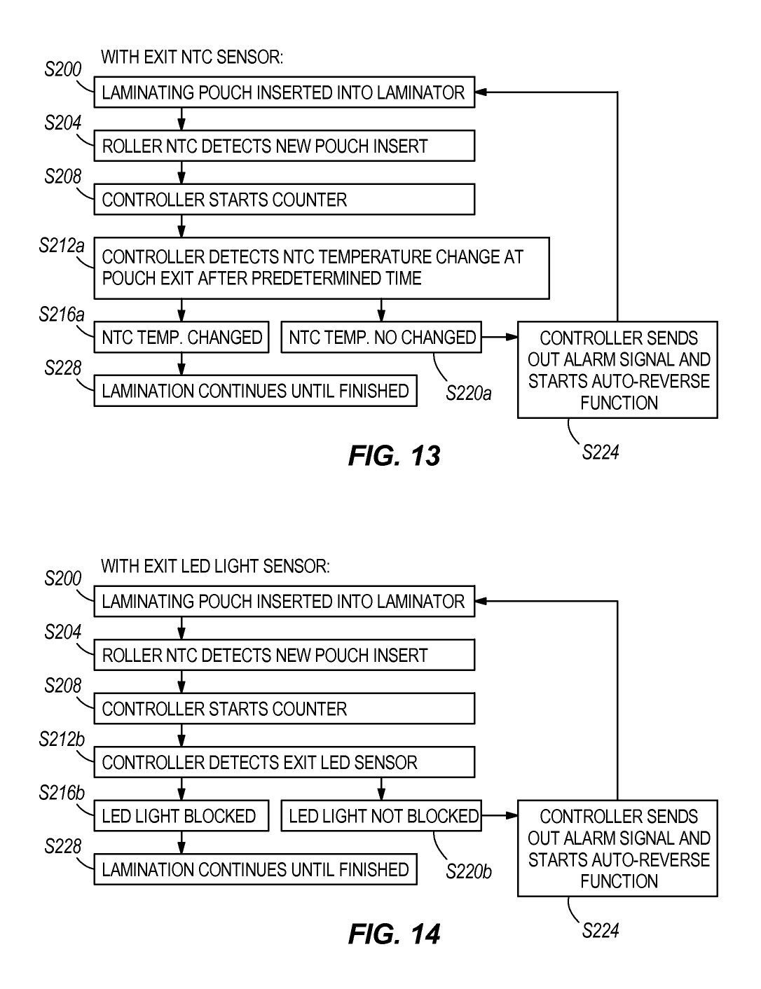

FIG. 13 illustrates a process flow diagram detailing the method for jam detection. The lamination pouch 214 is first inserted into the laminator 200 in step S200. Next, in step S204, the first sensor 211 detects a temperature drop on the surface of at least one of the rollers 205, indicating to the controller 240 that the pouch 214 has been inserted. The controller 240 starts a counter in step S208. After a pre-determined time (i.e., count) has elapsed, the controller 240 monitors the second sensor 213 in step S212a. If there is no jam, the second sensor 213 should detect a temperature change (rise) when the pouch 214 (now having an elevated temperature from being heated by the rollers 205) passes through the exit 221. If the second sensor 213 indicates a temperature increase (step S216a), the pouch 214 is deemed to be passing through the exit 221 normally, and the laminating process continues until finished (step S228). If the second sensor 213 does not indicate any temperature increase (step 220a), the pouch 214 is deemed to have jammed, and the controller 240 initiates the audio or visual alerting system 242 and starts an automatic reverse-feeding process in step S224.

FIG. 14 illustrates an alternate process flow diagram detailing a method for jam detection in which the second or “exit” sensor 213 includes an emitter and receiver LED pair, which can detect the successful exit of the pouch 214 when the light is blocked. The process flow diagram illustrated in FIG. 14 is similar to the process flow diagram of FIG. 13, and like steps have been given identical reference numerals. Only differences between the diagram of FIG. 13 and the diagram of FIG. 14 will be discussed. Once the predetermined time (i.e., count) has elapsed, the controller 240 monitors the LED emitter and receiver pair located at the laminator exit 221 (step S212b). If receiver indicates that the light from the emitter is blocked (step S216b), the pouch 214 is deemed to be passing through the exit 221 normally, and the laminating process continues until finished (step S228). If the receiver does not indicate any light blocking (step S220b), the pouch 214 is deemed to be jammed.

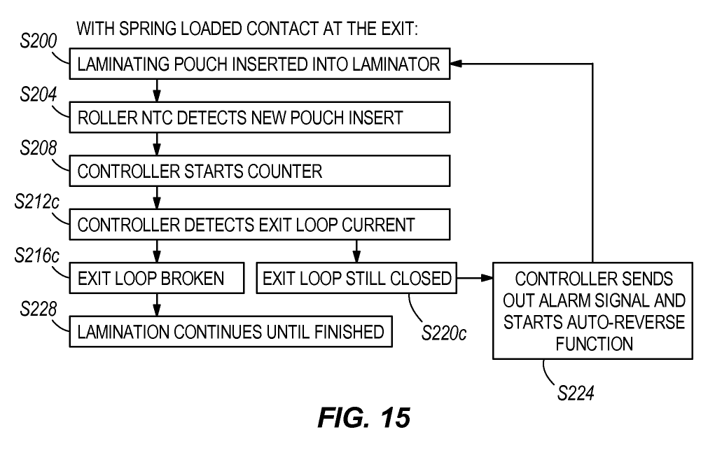

FIG. 15 illustrates another alternate process flow diagram detailing a method for jam detection in which the second or “exit” sensor 213 is a metal contact with spring pressure, which is located at the pouch exit 221. The process flow diagram illustrated in FIG. 15 is similar to the process flow diagram of FIG. 13, and like steps have been given identical reference numerals. Only differences between the diagram of FIG. 13 and the diagram of FIG. 15 will be discussed. Once the predetermined time (i.e., count) has elapsed, the controller 240 monitors an electrical circuit formed by the metal contact located at the laminator exit 221 (step S212c). The metal contact can be a leaf spring touching the surface of a metal exit plate. With the spring pressure, the metal contact is always at a closed state and forms a closed circuit loop. When the pouch 214 exits, it passes between the metal contact, thus breaking the closed loop (step S216c), and the pouch 214 is deemed to be passing through the exit 221 normally. If the closed loop is not broken (step S220c), the pouch 214 is deemed to have jammed. Thus, the laminator 200 can automatically detect the pouch exit.

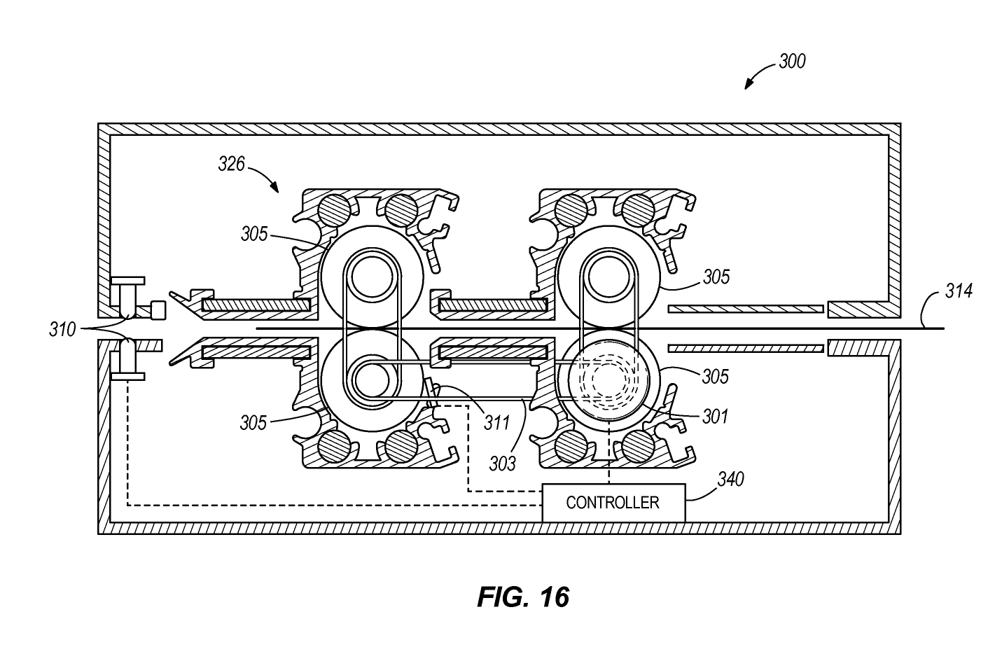

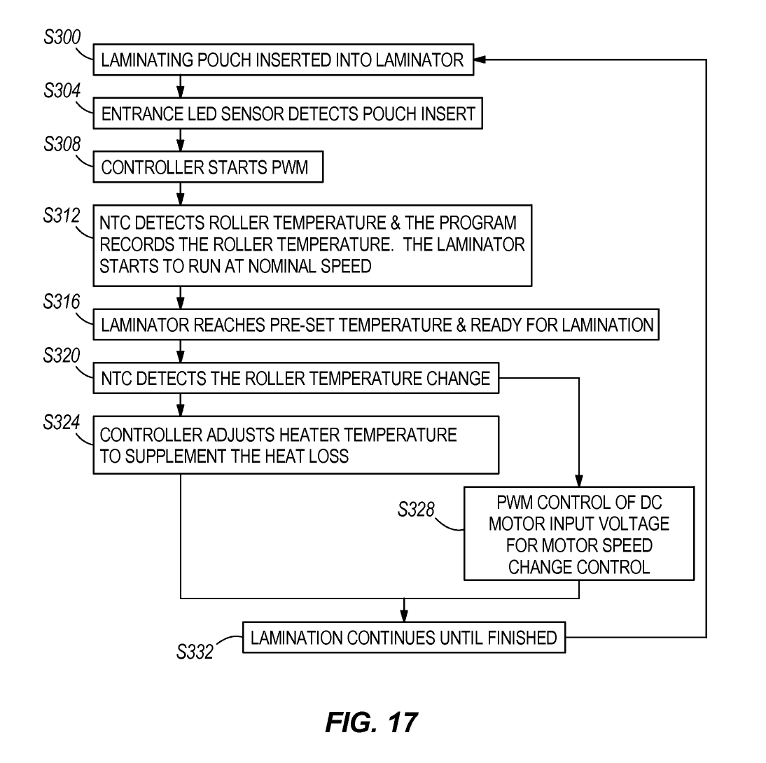

A lamination unit 300 and method are also contemplated for an automatic lamination process. The lamination unit 300 and process are illustrated in FIGS. 16-17. Similar to the lamination unit 200 described above, the lamination unit 300 includes a motor 301 and a set of rollers 305 driven by the motor 301 and disposed in a processing section 326 of the lamination unit 300. The rollers 305 are coupled to the motor 301 by a suitable drivetrain 303, illustrated schematically in FIG. 16. The drivetrain 303 may include belts, gears, shafts, or any other arrangement configured to transfer torque from the motor 301 to the rollers 305. As discussed below, a roller temperature management sensor 311 (which can be similar to the first sensor 211 described above) can be used for automating the pouch lamination process. The data from the sensor 311, which is indicative of temperature change on at least one of the set of rollers 305, is used for programmed control of the roller speed. A controller 340 within the laminator 300 calculates a heat loss value on the roller from the data from the sensor 311, and automatically adjusts the roller speed according to the heat loss value to provide good laminating performance. The heat loss value may indicate a specific type of pouch and/or article.

The lamination unit 300 may also include an entrance sensor 310 comprising an emitting and receiving LED pair. The controller 340 may energize the motor 301 in response to the entrance sensor 310 indicating that the lamination pouch 314 has been inserted into the lamination unit 300. In other constructions, the entrance sensor 310 may be omitted, and the motor 301 may be energized in response to a conventional switch. The controller 340 may also include the necessary hardware and firmware to control the motor 301 using pulse-width modulation (PWM). The average value of voltage (and current) fed to the load (i.e., the motor 301) is controlled by rapidly switching semiconducting transistors (e.g., MOSFETs, IGBTs, etc.) to block or conduct power between the supply and the load. The longer the conducting period compared to the blocking period, the more power is supplied to the load. This ratio, also referred to as a PWM Power/Voltage ratio, may be expressed as a percentage, with 100% corresponding to continuous connection between the supply and the load, and 0% corresponding to no connection between the supply and the load.

PWM can be applied to the laminator 300 to control the supply voltage to the motor 301 (e.g., a DC motor), or other drive device connected to one or more of the rollers 305 so that the motor speed (and roller speed) can be variably controlled by the controller 340. The temperature loss (heat loss) value on the roller is compared with (or correlated to) the PWM signal supplied to the motor 301. When the temperature loss on the roller 305 is detected, the corresponding PWM value is selected, and the motor speed (roller speed) is controlled accordingly.

In one example:
The setting temperature is 130 degrees C., and when the machine reaches the setting temperature, the standard speed V1 is 1000 mm/min.
When detected temperature loss reaches 2 degrees C., PWM Power/Voltage ratio adjusts the roller speed to 80% of V1—1000*0.80=800 mm/min.
When detected temperature loss reaches 4 degrees C., PWM Power/Voltage ratio adjusts the roller speed to 60% of V1—1000*0.60=600 mm/min
When detected temperature loss reaches 6 degrees C., PWM Power/Voltage ratio adjusts the roller speed to 40% of V1—1000*0.40=400 mm/min

FIG. 17 illustrates a process flow diagram detailing a method for a laminating process with automatic control as described above. The lamination pouch 314 is first inserted into the laminator 300 in step S300. Once the entrance sensor 310 detects that the pouch 314 has been inserted in step S304, the controller 340 starts a PWM cycle in step S308. In step S312, the controller 340 begins monitoring the temperature sensor 311 to determine if the temperature of at least one of the rollers 305 is at a pre-set temperature suitable for lamination. Once the pre-set temperature is met (S316), lamination commences, and the temperature sensor 312 detects a temperature change in at least one of the rollers 305 (S320). The controller 340 correlates the temperature change with a heater setting (S324) to compensate for the heat absorbed by the lamination pouch 314, and the controller 340 also adjusts the PWM signal supplied to the motor 301 (S328) to vary the motor speed (roller speed). The laminating process continues until the lamination pouch 314 is fully laminated (S332), then reverts back to the first step S300 to await insertion of a new lamination pouch 314.

No thickness sensor is needed to detect the pouch or article thickness for automatic pouch sensing and setting. Only the roller temperature data and the PWM firmware are needed to control variable speed of roller speed (e.g., DC motor). The laminator 300 with this PWM firmware control can automatically control lamination of a range of different thickness pouches (e.g., 3 Mil to 10 Mil pouches) without any manual settings. This is a fully automatic process of sensing pouches and setting laminating machine settings, and no manual settings are needed for different thicknesses of pouches and article. Thus user error is prevented as the user is not relied upon to correctly identify and enter information regarding the lamination pouch.

Various features of the invention are set forth in the following claims.

1. A laminating pouch comprising:
first and second plies;
a pre-sealed edge bonding the first and second plies; and
indicia included in the pre-sealed edge, the indicia corresponding to a property of the laminating pouch,
wherein the laminating pouch is configured to receive an article between the first and second plies and laminate the article when processed in a laminator.

2. The laminating pouch of claim 1, wherein the indicia are confined to the pre-sealed edge.

3. The laminating pouch of claim 1, wherein at least a portion of the indicia is translucent and a remaining portion of the pre-sealed edge is substantially transparent.

4. The laminating pouch of claim 3, wherein the indicia include at least one unsealed portion within the pre-sealed edge, and wherein the at least one unsealed portion is translucent, but not transparent.

5. The laminating pouch of claim 1, wherein the property of the laminating pouch represented by the indicia is a thickness of the laminating pouch.

6. The laminating pouch of claim 1, wherein the indicia are centered about a midpoint of the pre-sealed edge.

7. The laminating pouch of claim 6, wherein the indicia are confined to a central ⅓ of the pre-sealed edge.

8. The laminating pouch of claim 3, wherein the indicia are configured to change from translucent to transparent with the application of at least one of heat and pressure.

9. A method of forming laminating pouches comprising the steps of:
providing a web of laminating film;
dividing the web lengthwise into at least three ribbons including a first outer ribbon, a second outer ribbon, and a center ribbon;
forming a first laminating pouch by joining a portion of laminating film from the first outer ribbon and a portion of laminating film from the second outer ribbon; and
forming a second laminating pouch by joining two portions of laminating film from the center ribbon.

10. The method of claim 9, further comprising the step of sealing at least a portion of an edge of the first laminating pouch to create a pre-sealed edge and providing indicia in the pre-sealed edge.

11. The method of claim 9, wherein the indicia are confined to the pre-sealed edge.

12. The method of claim 9, wherein the indicia are translucent but not transparent, and a remaining portion of the pre-sealed edge is substantially transparent.

13. The method of claim 9, wherein the step of providing indicia includes maintaining at least one unsealed portion within the pre-sealed edge.

14. The method of claim 9, wherein the step of providing indicia includes centering the indicia about a midpoint of the pre-sealed edge.

15. The method of claim 9, further comprising the steps of:
dividing the web lengthwise into five ribbons including a fourth ribbon between the first outer ribbon and the center ribbon and a fifth ribbon between the second outer ribbon and the center ribbon; and
forming a third laminating pouch by joining a portion of laminating film from the fourth ribbon and a portion of laminating film from the fifth ribbon.

16. A laminating system including:
a laminating pouch; and
a laminator including an inlet configured to receive the laminating pouch, the laminator configured to laminate an article within the laminating pouch, and the laminator including a detector,
wherein the laminating pouch includes a pre-sealed leading edge configured to be inserted into the inlet of the laminator and containing indicia, and
wherein the detector is configured to read the indicia and to detect a property of the laminating pouch from the indicia.

17. The laminating system of claim 16, wherein the laminator is configured to interpret the indicia via the detector and set at least one of a heat setting and a speed setting of the laminator to process the laminating pouch.

18. The laminating system of claim 16, wherein the detector includes at least three sensor elements adjacent the inlet of the laminator.

19. The laminating system of claim 16, wherein the sensor elements are optical sensors.

20. The laminating system of claim 18, wherein the inlet of the laminator defines a width perpendicular to a working direction of the laminator, and wherein the at least three sensor elements are confined to a central ⅓ of the width of the inlet.

21. The laminating system of claim 20, wherein the detector includes five sensor elements.

22. The laminating system of claim 16, wherein the indicia include at least one unsealed portion, the unsealed portion being translucent but not transparent, and wherein a remaining portion of the pre-sealed edge is substantially transparent.

23. The laminating system of claim 22, wherein the detector is configured to discern between the at least one unsealed portion of the indicia and the remaining portion of the pre-sealed edge.

24-37. (canceled)
